(19) United States
(12) Patent Application Publication
(10) Pub. No.: US 2024/0062013 A1
(43) Pub. Date: Feb. 22, 2024

(54) DATA SUBJECT ASSESSMENT SYSTEMS AND METHODS FOR ARTIFICIAL INTELLIGENCE PLATFORM BASED ON COMPOSITE EXTRACTION

(71) Applicant: OPEN TEXT CORPORATION, Waterlo (CA)

(72) Inventors: Paul O’Hagan, Brooklin (CA); Isidre Royo Bonnin, Terrassa (ES); Robert Kapitan, Lachine (CA); Ravinder Reddy Yeddla, Hyderabad (IN); Renaud Levert, Montreal (CA)

(21) Appl. No.: 18/498,517

(22) Filed: Oct. 31, 2023

Related U.S. Application Data
(63) Continuation-in-part of application No. 17/977,432, filed on Oct. 31, 2022.
Application No. 17/977,432 is a continuation of application No. 17/508,820, filed on Oct. 22, 2021.
(60) Provisional application No. 63/421,122, filed on Oct. 31, 2022.

(51) Int. Cl. G06F 40/295; G06F 16/33; G06F 16/34; G06F 16/38; G06F 40/30

(52) U.S. Cl. CPC G06F 40/295; G06F 16/3344; G06F 16/34; G06F 16/38; G06F 40/30

(57) ABSTRACT

Responsive to user interaction, a data subject assessment service, hosted on an artificial intelligence (AI) platform operating in a cloud computing environment, is operable to define a data subject, create and configure a data subject project, and add the data subject to the data subject project. The data subject project is associated with AI models, each of which models a risk having a user-adjustable risk level. The data subject project thus configured and/or customized, for instance, with a custom rule, can be run on a collection of documents to assess the data subject through data subject assessment operations. Data subject assessment results thus produced can be searched for data subject relationships, using metadata from the data subject assessment operations. This fine-tunes the data subject assessment results and produces more granular, more precise results, based on which a report can be viewed and/or generated.

### CROSS-REFERENCE TO RELATED APPLICATIONS

This application claims a benefit of priority under 35 U.S.C. § 119(e) from U.S. Provisional Application No. 63/421,122, filed Oct. 31, 2022, entitled “DATA SUBJECT ASSESSMENT SYSTEMS AND METHODS FOR ARTIFICIAL INTELLIGENCE PLATFORM BASED ON COMPOSITE EXTRACTION,” which is fully incorporated by reference herein for all purposes. This application is a continuation-in-part of, and claims a benefit of priority under 35 U.S.C. § 120 from, U.S. patent application Ser. No. 17/508,820, filed Oct. 22, 2021, entitled “COMPOSITE EXTRACTION SYSTEMS AND METHODS FOR ARTIFICIAL INTELLIGENCE PLATFORM,” and U.S. patent application Ser. No. 17/977,432, filed Oct. 31, 2022, entitled “COMPOSITE EXTRACTION SYSTEMS AND METHODS FOR ARTIFICIAL INTELLIGENCE PLATFORM,” both of which are fully incorporated by reference herein for all purposes.

### FIELD OF THE INVENTION

This invention relates generally to artificial intelligence. More particularly, this invention relates to composite extraction systems, methods, and computer program products with natural language understanding for an artificial intelligence platform. Even more particularly, this invention relates to data subject assessment systems, methods, and computer program products for an artificial intelligence platform based on composite extraction.

### BACKGROUND OF THE RELATED ART

Artificial intelligence (AI) generally refers to the intelligence demonstrated by machines, in contrast to the natural intelligence displayed by humans or animals. Within the field of AI, natural language processing (NLP) refers to the ability of machines to read and understand human language.

In practice, an AI platform may provide NLP capabilities such as concept extraction, named entity extraction, and text classification. For instance, a concept extraction module may be configured for extracting and ranking tokens, nominal and/or verbal keywords and key phrases; a named entity extraction module may be configured for identifying, extracting, ranking, and unifying and normalizing named entities using AI models and dictionaries; and a text classification module may be configured for classifying and ranking the content of documents according to taxonomies automated in AI (i.e., machine learning) models.

Natural language understanding (NLU) or natural language interpretation (NLI) is a subtopic of NLP that concerns the reading comprehension of machines. In practice, an AI platform may provide NLU capabilities such as sentiment analysis and summarization. Sentiment analysis concerns the detection of subjectivity, tonality, emotions, and intentions, and the ranking of sentences, entities, and documents. Summarization concerns the extraction of most relevant sentence according to topics of interest, rules, and keywords.

Unfortunately, these NLU capabilities are very difficult to achieve in the real world. Therefore, there is a continuing need for innovations and improvements in the field of AI-related technologies and capabilities. This disclosure can address this need and more.

### SUMMARY OF THE DISCLOSURE

A goal of this disclosure is to provide more granular assessment on data subjects. In some embodiments, this goal can be achieved through a data subject assessment method that includes defining a data subject, creating a data subject project, configuring the data subject project, adding the data subject to the data subject project, and running the data subject project.

The defining the data subject can be performed by a data subject assessment service responsive to an instruction from a user, the instruction received through a user interface of the data subject assessment service, the data subject assessment service hosted on an artificial intelligence (AI) platform operating in a cloud computing environment. The creating the data subject project can include associating the data subject project with a plurality of AI models, each of which models a risk with a user-configurable risk level. Alternatively or additionally, a file containing data subject information can be imported.

The data subject project can be configured and/or customized in various ways, including setting each modeled risk at a risk level responsive to a setting received through the user interface of the data subject assessment service. Further, custom risks and rules or even another data subject can be added to the data subject project.

Responsive to an instruction to run the data subject project, a previously-selected and/or provisioned analytic engine is operable to access a data source where the collection resides, retrieve a document from the collection, and perform data subject assessment operations on the document. The data subject assessment operations can comprise text mining operations and application of rules. These text mining operations produce metadata about the document and the application of rules leverages the metadata and applies an action to the document when a condition is met. The data subject assessment operations produce data subject assessment results that can be viewed/browsed.

The data subject assessment results can be searched for data subject relationships based on user-selected criteria. This produces a subset of the data subject assessment results. Documents in this subset can more precisely related to one another because, for instance, they all mention the data subject, are at the same risk level, and are assessed as having the same risk or risk type. A report can be visualized and/or generated on this subset of the data subject assessment results. At this point, the data subject project can be closed or further customized for another run.

In some embodiments, an action can be taken on the data subject assessment results or a selection thereof. An example of an action is to move the documents thus selected to a secure location. Another example of an action is to delete the selected documents.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. The features illustrated in the drawings are not necessarily drawn to scale.

FIGS. 1A-1B depict an example of a user interface of a data subject assessment service with a data subject creation function and a data subject import function according to some embodiments disclosed herein.

FIG. 2 depicts an example of a user interface of a data subject assessment service for creating a data subject project according to some embodiments disclosed herein.

FIG. 3 depicts an example of a data subject project dashboard before running a data subject project according to some embodiments disclosed herein.

FIG. 4 depicts an example of a data subject project configuration interface according to some embodiments disclosed herein.

FIGS. 6-8 depict examples of AI models and risks with user-configurable risk levels provided by a data subject assessment service according to some embodiments disclosed herein.

FIG. 9 depicts an example of a data subject project dashboard after a data subject project is run according to some embodiments disclosed herein.

FIG. 10 depicts an example of an AI modeling configuration interface that can be used to add a risk based on one or more classifications according to some embodiments disclosed herein.

FIG. 11 depicts an example of an AI modeling configuration interface that can be used to add a risk rule or rule group according to some embodiments disclosed herein.

FIG. 12 depicts an example of a data subject assessment results page showing relevant documents from the data subject assessment results based on user-selected criteria according to some embodiments disclosed herein.

FIGS. 13-15 each depicts an example of a visualization or report that shows results from assessing a collection of documents referencing a data subject specified in a data subject project according to some embodiments disclosed herein.

FIG. 16 depicts an example of a data subject assessment results page showing a set of documents from the data subject assessment results selected for an administrative action according to some embodiments disclosed herein.

FIG. 17 depicts an example of a method for data subject assessment according to some embodiments disclosed herein.

FIG. 18 depicts a diagrammatic representation of an example of a distributed network computing environment for implementing embodiments disclosed herein.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As alluded to above, NLP/NLU capabilities are very difficult to achieve in the real world. An issue here relates to the accuracy of results from NLP/NLU processes. In practice, the accuracy of NLU processing results can be affected by the quality of inputs (e.g., extracted named entities, extracted concepts, etc.) to the NLU processes.

For example, suppose concepts like “airport,” “fly,” and “London” could be extracted (e.g., by a concept or named entity extraction modules) from a document along with the word “aircraft.” A machine with a machine learning model could recognize that the set of extracted concepts follow a pattern of known phrases in English. However, the pattern of known phrases is associated to other concepts and phrases with a wide range of possible relationships and multiple classifications in a taxonomy. While the machine could determine a probability for each of the possible concepts and classify the document as belonging to one of the taxonomy labels, the results are based on either individual probabilities or knowledge base gathered information (e.g., average generic values gathered in a knowledge base). Consequently, inputs to the NLU processes may already be skewed. The inaccuracies that may already be present in the inputs to the NLU processes can affect the ability of the machine to accurately comprehend the meaning of the document. As a result, the outcome is often less than satisfactory.

U.S. Patent Application Publication Nos. 2023/0131066 and 2023/0127562, which are incorporated by reference herein, provide examples of AI-based composite extraction techniques and example use cases of composite AI extraction rules that can be used to combine results from a composite of AI models to reach a conclusion with a higher degree of truth than what the individual results from these AI models could reach. Operationally, a composite of AI models involves a first layer of AI models such as concept extraction (CE), named entity extraction (N-EE), text classification (TC), and sentiment analysis (SA). At a second layer, a rules module can apply composite AI extraction rules for composite AI extraction by combining various operations and/or metadata produced thereby. The rules module is adapted for capturing annotation contexts through controlled vocabularies, determining relationships as attribute values, pre-tagging texts of interest, and generating deducted, validated, and/or enriched metadata. Architecturally, the rules module can be considered as part of a text mining system that operates an ingestion pipeline that ingests input data from disparate sources and that produces a variety of metadata for indexing, big data analytics, and so on. A rules builder can be used to build composite AI extraction rules through a user interface. The rules builder can include a coding tool for defining rules scope and order using a high-level programming language.

In some embodiments, AI-based composite extraction can focus on discovery and assessment/analysis of data of interest, which is referred to herein as a “data subject” and which can be considered as a type of risk. While anything could be defined as a data subject (e.g., a named entity, a legal entity, a user, a company, a product, an event, a place, a topic, a keyword, etc.), for the sake of illustration, a data subject refers to any individual person who can be identified, directly or indirectly, via an identifier such as a name, an ID number, location data, or via factors specific to the person's physical, physiological, genetic, mental, economic, cultural or social identity.

For instance, disclosure of some data (e.g., person name, credit card number, social security number, etc.) under certain circumstances may pose a risk (e.g., a compliance risk, an exposure risk, etc.). The AI-based composite extraction framework can identify and assess such a risk more accurately by finding out how sets of metadata relate to one another and, based on their relationship(s), determining risks and/or risk levels.

As a non-limiting example, a file share on an information system (e.g., an enterprise content management system) can be examined to look for documents with particular data subject and data of interest relating to the data subject (e.g., a document discussing certain skills, an image with graphic violence or hate speech, an email with an email address, etc.). This examination produces metadata for the content. Some embodiments provides an interactive tool for analyzing the metadata produced by the AI-based composite extraction and generating various types of outputs such as dashboards, visualizations, reports, etc., for instance, personally identifiable information (PII) and personally sensitive information (PSI) reports.

As a non-limiting example, the interactive tool comprises a data subject assessment system. In one embodiment, the data subject assessment system can be implemented as a stateless REST service provided by an AI platform to process documents and identify and assess data subject(s). In some embodiments, the data subject assessment service is operable to uncover enterprise compliance risks from text, images, video, and audio content and includes AI-powered content analytics capabilities to scan, examine, and tag or flag for integration with automated workflows/processes/applications and/or for human review.

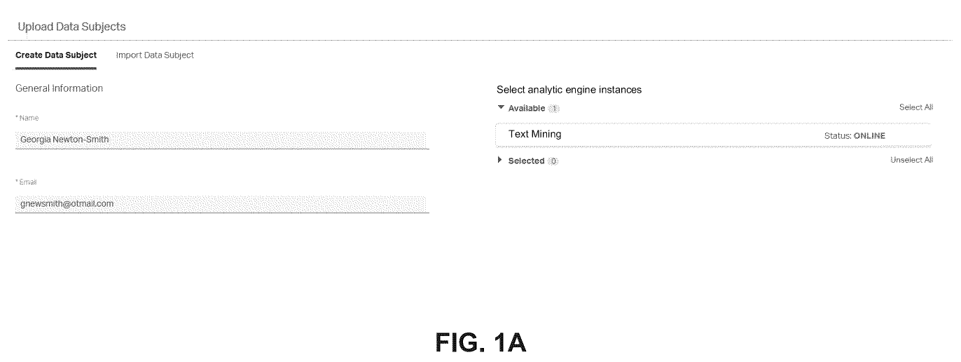

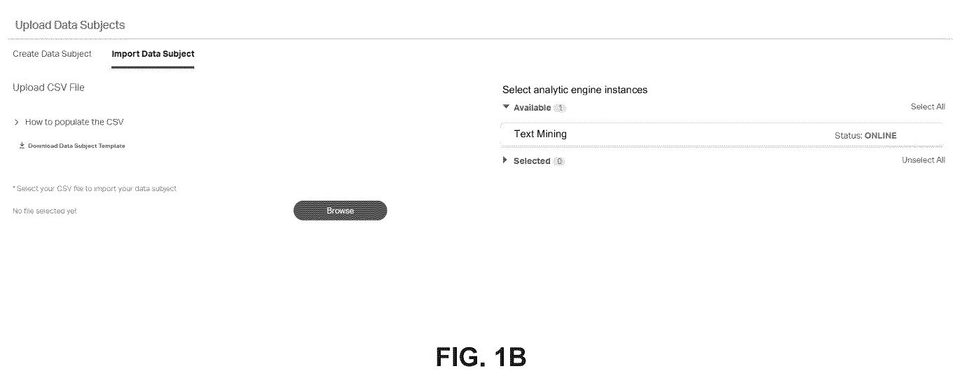

In some embodiments, the data subject assessment service comprises a creation function for creating a data subject and an import function for importing a file containing previously defined data subject(s). FIGS. 1A-1B depict an example of a user interface of the data subject assessment service with the data subject creation function (FIG. 1A) and the data subject import function (FIG. 1B).

In some embodiments, the data subject assessment service provides a data subject template that an authorized user (e.g., a data scientist, a data security analyst, or whoever is tasked with managing the data subject project, for instance, for compliance reasons, and has access to a collection of documents stored at a data source) can download and populate data fields in the data subject template to create a data subject file, such as a comma-separated values file (CSV) that contains data subject information. These files can be centrally stored on the AI platform and accessible by instances of an analytic engine operating on the AI platform. Depending upon the size of each data subject project, one or more instances of the analytic engine may be provisioned. Examples of a suitable an analytic engine (e.g., a text mining engine) can be found in the above-referenced U.S. Patent Application Publication Nos. 2023/0131066 and 2023/0127562. Other analytic engines may also be used to run data subject assessment projects.

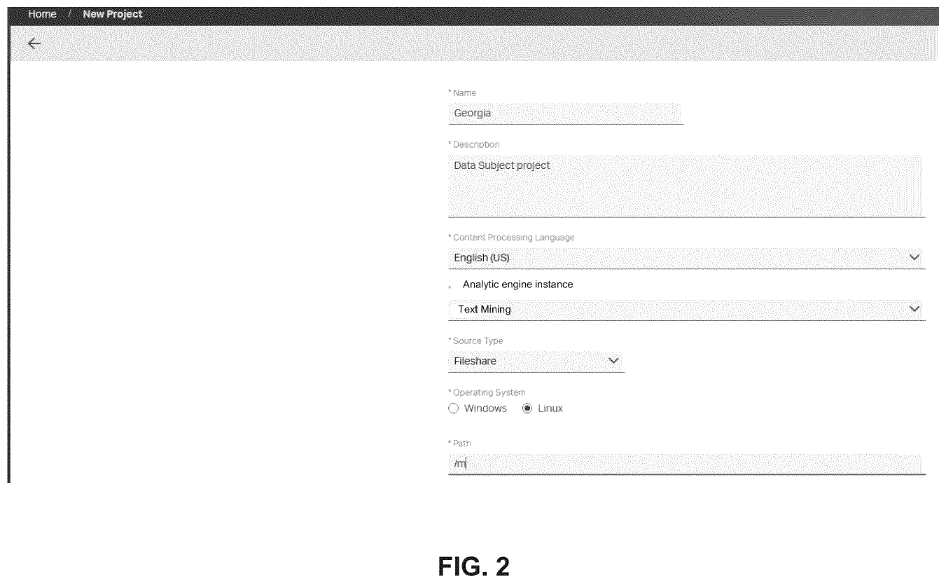

As a non-limiting example, a data subject assessment process can begin with the creation of a data subject (e.g., “Georgia Newton-Smith” as shown in FIG. 1A) and/or by importing a file (e.g., a CSV file, as shown in FIG. 1B) that contains data subject information. Based on the data subject information thus provided through the user interface or imported from the file, a data subject project (e.g., “Georgia”) can be created for assessing the data subject, as illustrated in FIG. 2.

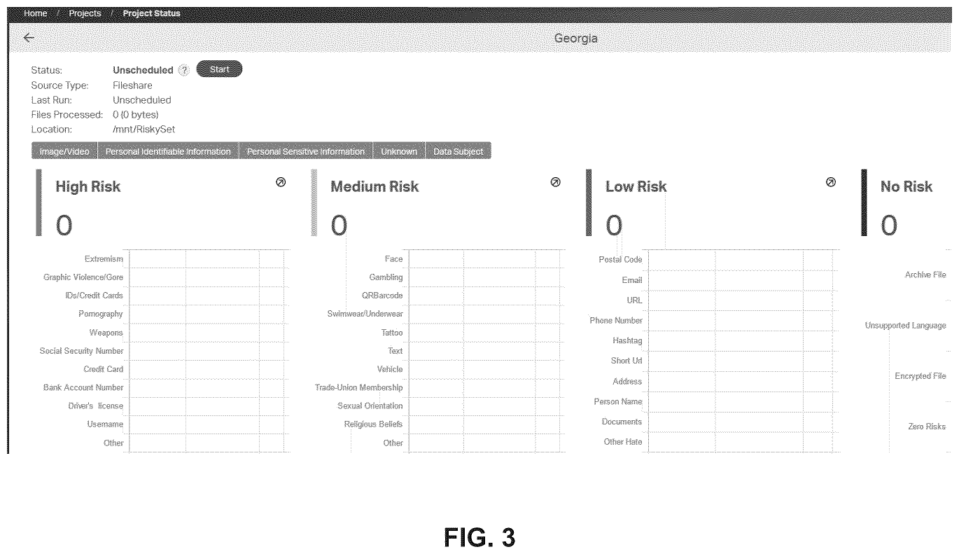

Once the data subject project is created, the data subject assessment service is operable to generate a data subject project view (or dashboard) for presenting AI models and potential risks associated with the particular data subject project. An example of a data subject project dashboard is illustrated in FIG. 3. In this example, the data subject assessment has not started, so the data subject project dashboard initially shows empty fields.

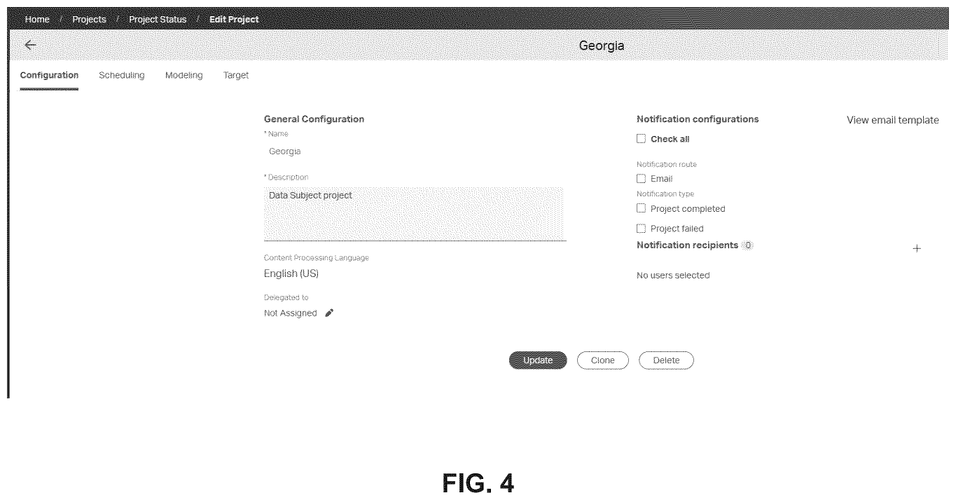

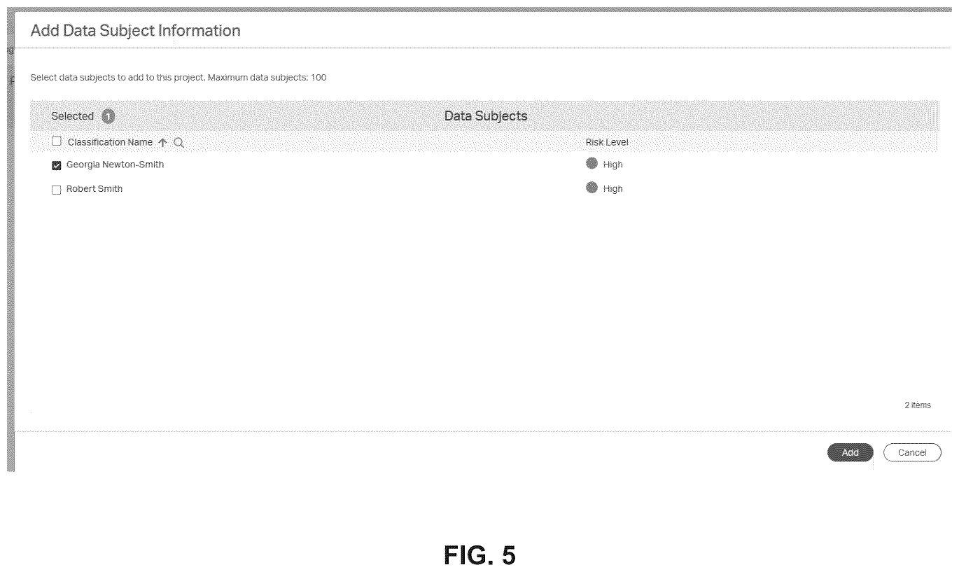

In some embodiments, the data subject assessment service provides a project edit function through which the data subject project can be further configured, for instance, for scheduling a run of the data subject project, sending a notification on the status of the data subject project, selecting a recipient of the notification, etc. FIG. 4 depicts an example of a user interface for the project edit function.

At this point, the specific (previously defined) data subject (e.g., “Georgia Newton-Smith”) can be added to the data subject project. This is illustrated in FIG. 5. Through the “Add Data Subject Information” page provided by the data subject assessment service, the user can add any previously defined data subject(s) to the data subject project, whether the previously defined data subject is created dynamically through the interactive user interface (e.g., FIG. 1A) or by importation (e.g., FIG. 1B). As a non-limiting example, suppose another data subject, “Robert Smith,” is related to the data subject, “Georgia Newton-Smith,” the user can add the data subject, “Robert Smith,” to the data subject project, “Georgia,” such that, at assessment time, the data subject assessment service is operable to search and assess documents containing both data subjects (“Robert Smith” and “Georgia Newton-Smith”).

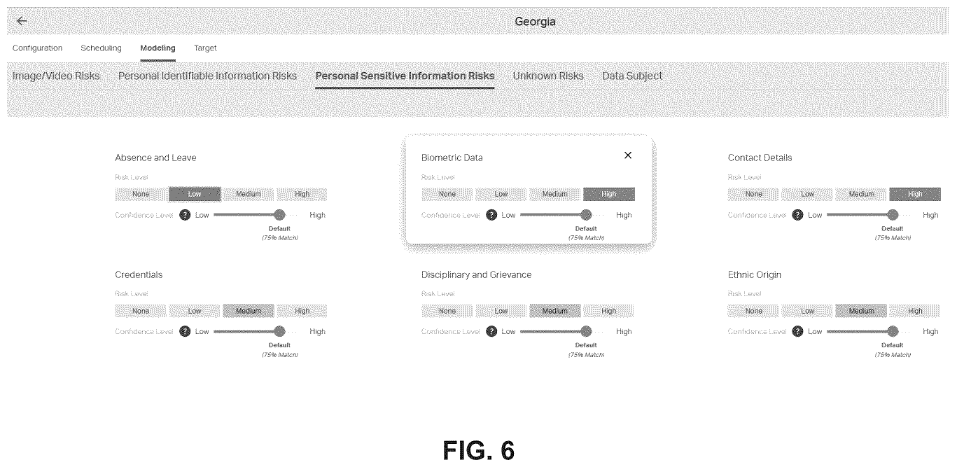

In some embodiments, the data subject assessment service provides a plurality of AI models and risks that can be configured for a data subject project. In some embodiments, the data subject assessment service provides an interactive tool for an authorized user to specify risk levels individually for various types of risks. Examples of AI models and risks provided by the data subject assessment service are illustrated in FIGS. 6-8.

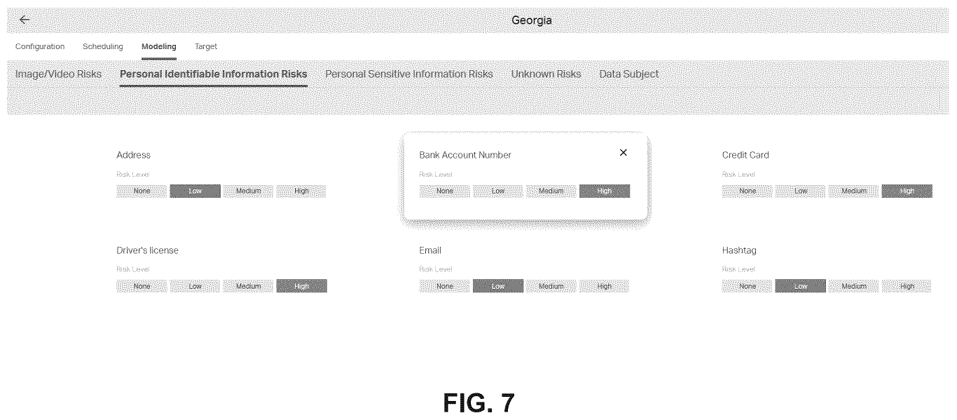

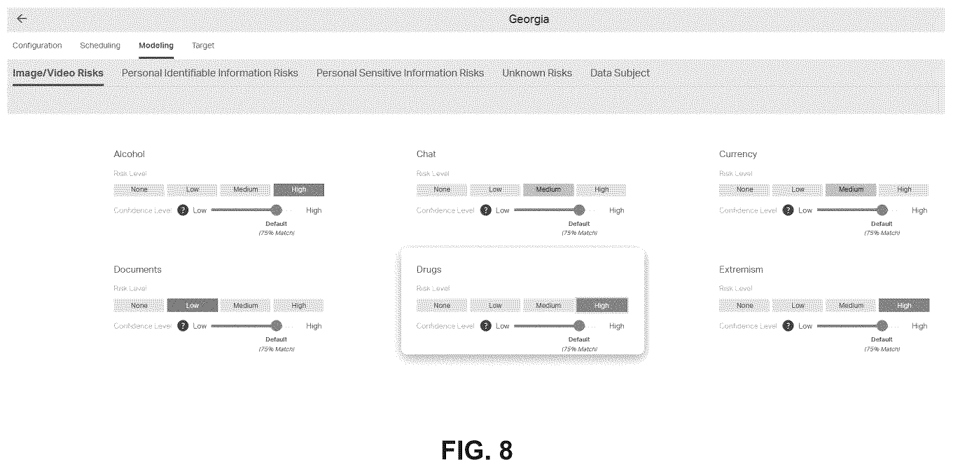

Specifically, FIG. 6 depicts an example of an interactive user interface for configuring the risk levels for different types of modeled PSI risks (e.g., absence and leave, credentials, biometric data, disciplinary and grievance, contact details, ethnic origin, etc.). FIG. 7 depicts an example of an interactive user interface for configuring the risk levels for different types of modeled PII risks (e.g., address, driver's license, bank account number, email address, credit card number, hashtag, etc.). As discussed below, new PII risks can be added by rules. An example of a rule builder that can be utilized to build new rules is described in the above-referenced U.S. Patent Application Publication No. 2023/0127562. FIG. 8 depicts an example of an interactive user interface for configuring the risk levels for different types of modeled image/video risks (e.g., images and/or videos tagged with alcohol, chat, currency, documents, drugs, extremism, etc.).

Returning to FIG. 3, the user can start to run an assessment job on the data subject project by selecting the “start” button shown on the data subject project dashboard. In response, the instance of the analytic engine (selected by the user via the user interface shown in FIG. 2) begins to apply individual AI models to files containing the data subject. For example, the instance of the analytic engine may apply an AI model on “Contact Details” to the files stored at a data source (e.g., a “Fileshare”, a content server, a work space, etc.) that contain the data subject.

In some embodiments, the data subject assessment can include a sentiment analysis, text classification, and application of rules, but does not always use the same set of rules. Rather, through the data subject project dashboard, an authorized user can configure a “risk” level (e.g., high, medium, low), how much tolerance they have for that particular category.

For instance, for the category “bullying”, the tolerance level might be set at “low”, which corresponds to a lower threshold for the underlying system to determine that the language was risky. As illustrated in FIGS. 6-8, each category can have its own toggle or configurable risk indicator.

Also, risks can be weighed using confident scores. For instance, a sentiment found in a document could be anger and the context could be a joke. When the two pieces of data are combined, even though the sentiment is “serious,” it is in the context of a “joke” which weighs more than “serious,” and, therefore, an associated risk level might be low. Such a risk analysis is flexible and more accurate than an analysis that is based on a single classification result. Additional examples of risk analyses can be found in the above-referenced U.S. Patent Application Publication Nos. 2023/0131066 and 2023/0127562.

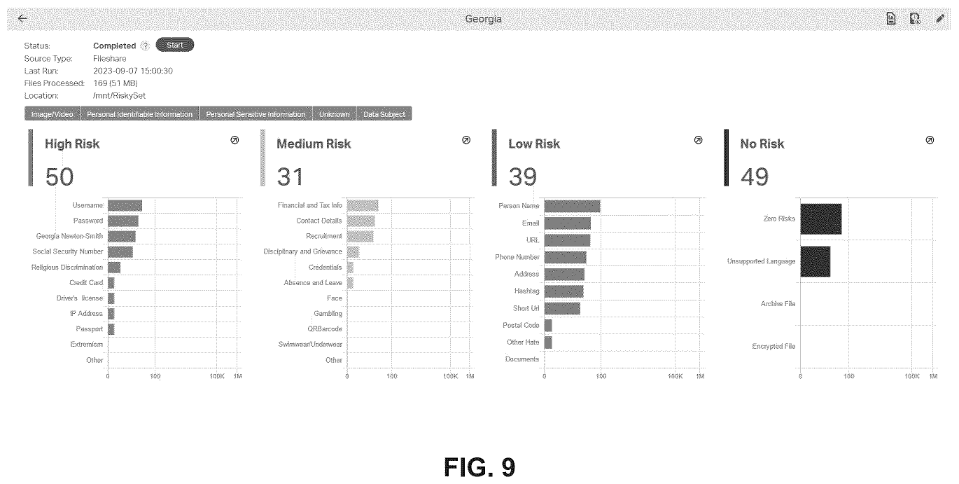

In some embodiments, the data subject assessment job can be manually terminated and started again or it can be run automatically to completion. When the job is completed, assessment results with respect to various levels of risks associated with the data subject are presented through the data subject project dashboard, as illustrated in FIG. 9. At this time, the user can start the assessment again, customize data subject project and run the assessment again, or the user can generate a report and close the data subject project.

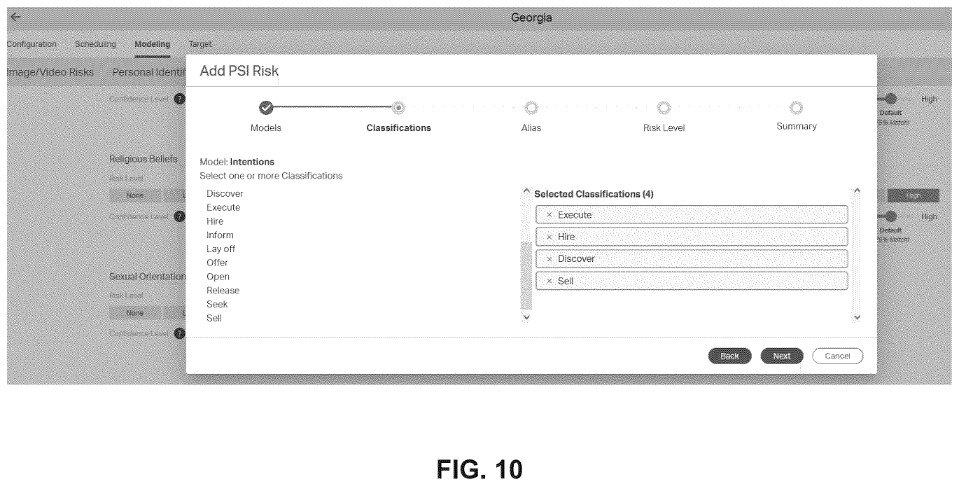

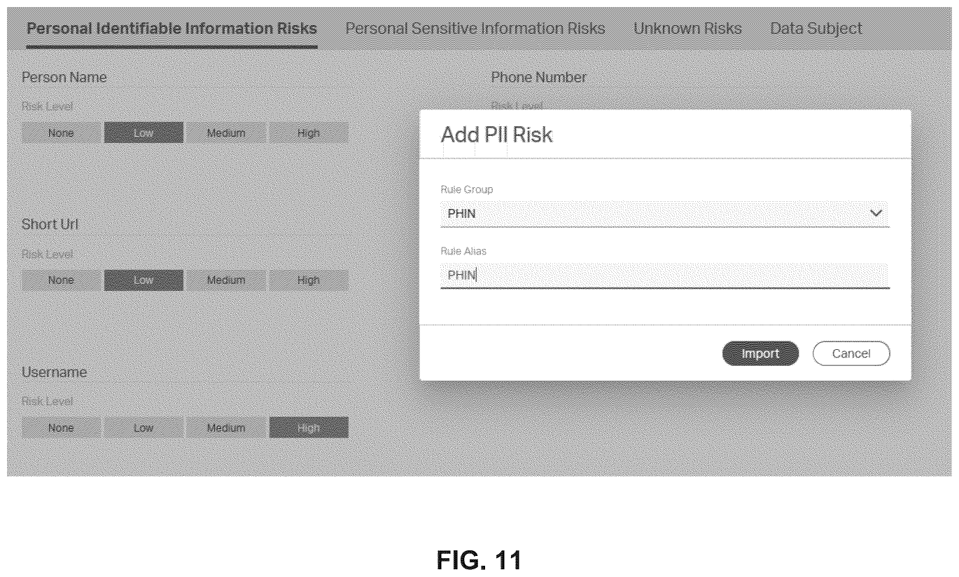

In some embodiments, risks that are not provided by the data subject assessment service can be added to the data subject project. As illustrated in FIG. 10, new classifications can be added within the data subject project to combine with a data subject and annotations. In the example of FIG. 10, classifications “Execute”, “Hire”, “Discover”, and “Sell” are selected as new (custom) PSI risks to be added to the data subject project. In the example of FIG. 11, a custom PII risk can be added by specifying and importing a rule or rule group into the data subject project. As discussed above, such a rule or rule group can be built using a rule builder. In this way, the data subject project can be customized and run again and again to fine tune the results on demand, at any given time.

In some embodiments, the data subject assessment service provides a search function that allows a user to search the results generated from the project (by applying AI models on the various risks to the data subject) and drill down to a particular document to find more information on the data subject and/or in combination with some criteria. Referring back to FIG. 3, as a non-limiting example, to search for metadata that may relate to the data subject and that may be added to the data subject, a user can select a risk level (e.g., “High Risk”, “Medium Risk”, “Low Risk”, or “No Risk”) shown in the data subject project dashboard. In response, the user is directed to a results page with files assessed or otherwise identified at the selected risk level.

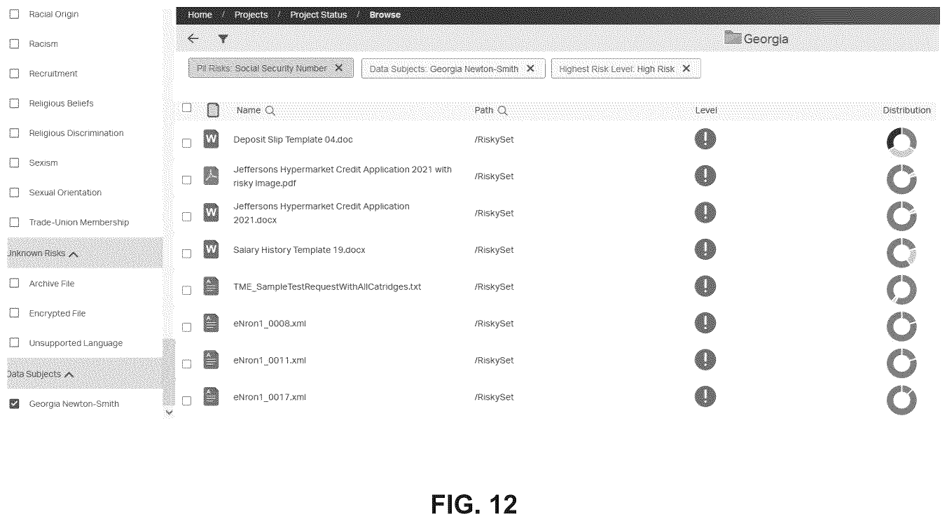

FIG. 12 depicts an example of a user interface for the search function. In the example of FIG. 12, data subject assessment results can be filtered, narrowed, or otherwise fine-tuned to identify files at a specific risk level containing a particular data subject in combination with a specific PII risk.

In some embodiments, the search function may leverage a variety of metadata produced by the analytic engine which also runs the data subject assessment. As a non-limiting example, the text mining engine described in the above-referenced U.S. Patent Application Publication Nos. 2023/0131066 and 2023/0127562 is operable to ingest input data from disparate sources and produce a variety of metadata for indexing, big data analytics, and so on. More specifically, the text mining engine is operable to perform a composite AI extraction operation that includes concept extraction (CE), named entity extraction (N-EE), text classification (TC), sentiment analysis (SA), and application of composite AI extraction rules to produce CE metadata (e.g., extracted concepts, extracted keywords/key phrases, etc.), N-EE metadata (e.g., named entities), TC metadata (e.g., text classifications), SA metadata (e.g., sentiments, tonality, emotions, intentions, etc.) and various other metadata, including deduced, validated, and/or enriched metadata. The text mining engine may also perform metadata-producing operations, such as ETL, IoT, web service, etc., independently or in conjunction with the composite AI extraction operation. As a result, there is a wealth of metadata associated with each AI model, as well as each risk, that can be added to a data subject project to thereby obtain more granular, more precise results.

That is, in addition to identifying and validating content at risk (e.g., PII, PSI, etc. for compliance reasons), analysis results can be combined to improve accuracy. For instance, a particular data subject in input documents can be identified and the accuracy can be enhanced when the data subject is combined with the metadata “SSN” and the metadata “high risk”. When combined with “sentiment analysis” and/or “text classification” through the AI-based composite extraction, the accuracy of a data subject assessment can be further enhanced.

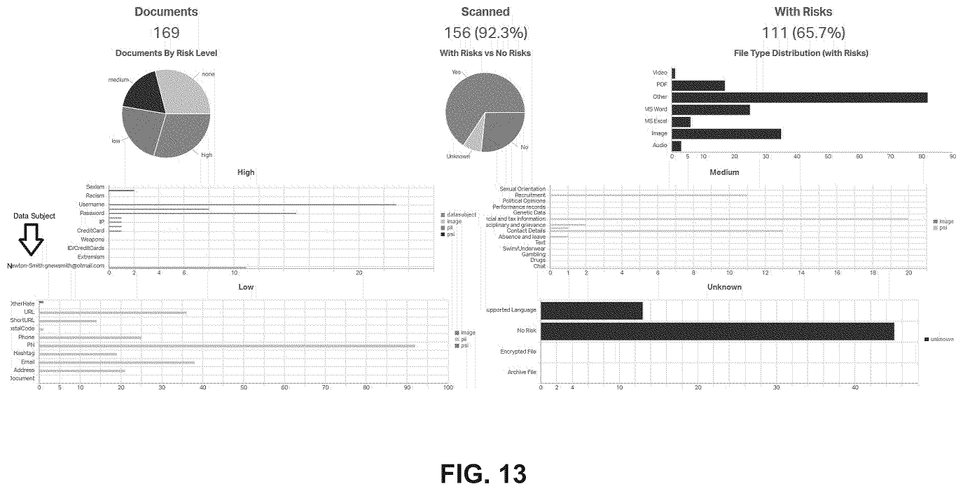

In some embodiments, the data subject assessment service includes a report generation function for generating a visualization of the results from assessing the data subject project. The results of running a data subject assessment project can be visualized, produced, and/or otherwise generated in various ways (and in different languages where applicable). Examples of different kinds of reports are illustrated in FIGS. 13-15.

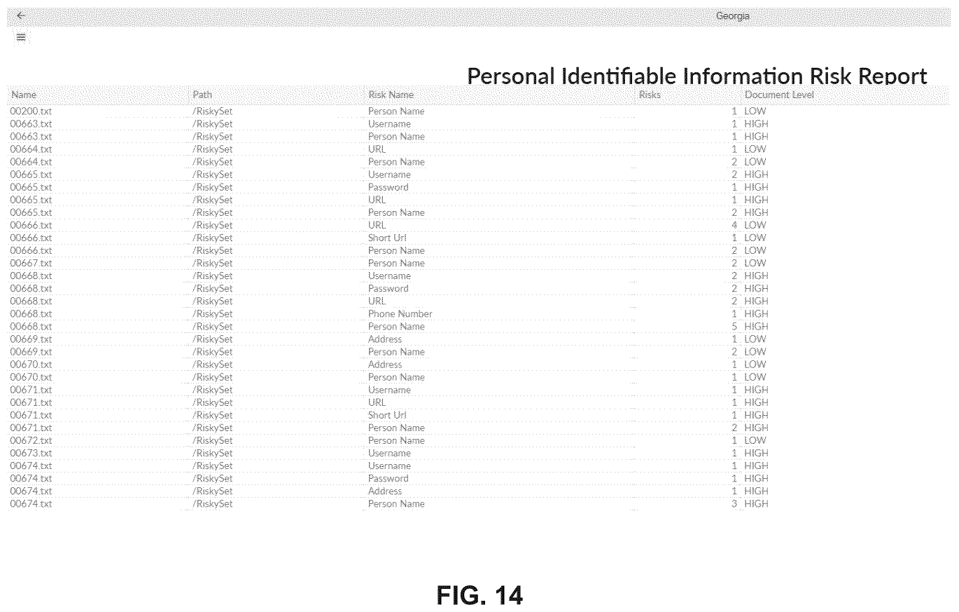

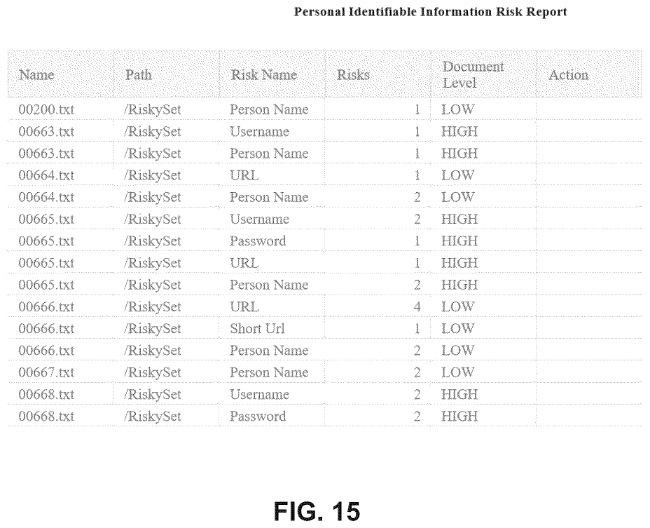

In the example of FIG. 13, the report shows results from assessing a collection of documents referencing the particular data subject specified in the data subject project. Some of these documents are categorized (per an AI model on IP addresses) as having an IP address that is considered a low risk, some of the documents are categorized (per an AI model on sexism) as mentioning sexism that is considered a medium risk, and so on. While only a small number of documents is shown in FIG. 13, those skilled in the art will appreciate that a collection may contain hundreds of thousands, if not millions, of documents in some cases. FIG. 14 depicts a screenshot of a RII risk report dynamically generated and presented through a user interface. FIG. 15 shows that the result can be exported into a file (e.g., in PDF) that can then be distributed via different communication channels.

In this way, the data subject assessment services provides an ability to detect potentially offensive or unwanted text, images, and videos through prebuilt AI models for categories such as hate speech, weapons, alcohol and drug use, offensive material, and so on. In some embodiments, the data subject assessment service is also operable to check for PII (e.g., person names, social security numbers, credit card numbers, banking information, etc.) as well as PSI (e.g., hate speech identification, content with racial bias, content with gender bias, etc.).

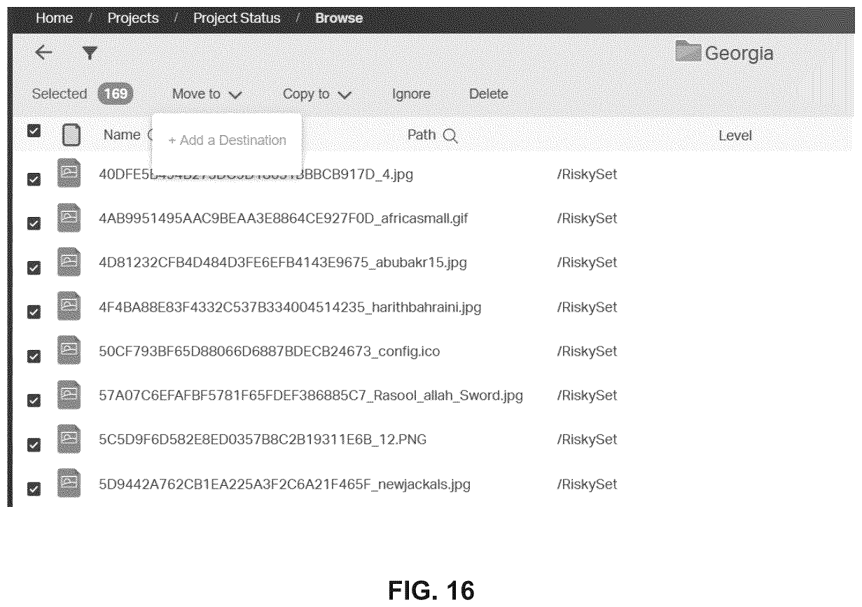

In some embodiments, particular actions may be taken on certain data subject files from assessing a data subject. For example, an administrator may take action to move data subject files assessed at high risk from a file share location to a secure location. A non-limiting example of such an action is illustrated in FIG. 16. In this example, after reviewing a report that shows 169 data subject files as high risk, these files are selected for moving to a more secure destination or for deletion.

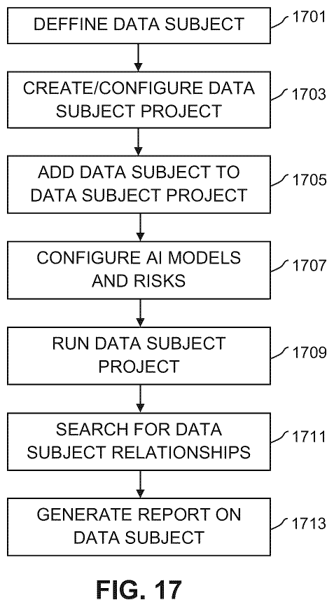

Referring to FIG. 17, which illustrates an example of a method for data subject assessment, in some embodiments, the method can include defining a data subject (1701). As discussed above, the data subject can be defined through a user interface provided by a data subject assessment service hosted on an AI platform operating in a cloud computing environment or imported from a file containing data subject information using an import function of the data subject assessment service. The method may further include creating and configuring a data subject project (1703). Configuring the data subject project may include selecting an instance of an analytic engine operating on the AI platform, selecting a processing language, selecting a data source where a collection of documents to be assessed is stored, and so on. Then, the data subject can be added to the data subject project (1705). When the data subject project is created, it is programmatically associated with a default set of AI models and associated risk levels. At this point, the data subject project can be customized by adding more data subject(s) as well as individually configuring the AI models and associated risk levels (1707). Then, to assess the data subject, the data subject project is run (1709).

In some embodiments, responsive to an indication received by the selected instance of the analytic engine (which is hereinafter referred to as the “engine”) through a user interface of the data subject assessment service (e.g., a data subject project dashboard), the engine is operable to access the identified data source, retrieve documents from the collection, and perform data subject assessment operations on the documents thus retrieved. The data subject assessment operations can include text mining operations and application of rules. The text mining operations produce a variety of metadata about the documents. The application of rules leverages the metadata and applies actions to the documents when certain conditions are met. For instance, a rule may specify using the tonality of a document from a sentiment analysis to classify the document according to a relevant taxonomy. Another rule may specify classifying documents of a particular type under a specific category. A rule builder can be used to build custom rules that identify PII risks. These custom rules can be added to the data subject project which, in turn, helps to produce more granular and more precise results.

In some embodiments, the data subject project can be customized multiple times at any given time. As a non-limiting example, a user may stop running the data subject project, update the data subject project with another PSI risk and/or PII risk rule, and run the updated data subject project. Alternatively, the user may allow the data subject project to run to its completion, review the data subject assessment results via the data subject project dashboard, and then customize the data subject project or choose to generate a report on the data subject assessment results.

In some embodiments, the data subject assessment results are presented through the data subject project dashboard as “risk cards” (e.g., “High Risk”, “Medium Risk”, “Low Risk”, and “No Risk” cards each with a bar diagram showing a number or percentage of documents that a combination of metadata modeled as having the respective high, medium, low, or risks). The user may wish to review these risk cards and search for data subject relationships in the data subject assessment results (1711). When a risk card is selected, the user is directed to a results page that lists documents assessed at the respective risk level. The results page may have a search function for searching a subset of the documents listed on the results page, for instance, those referencing the data subject and assessed as having a particular PII risk at a particular risk level.

In some embodiments, before or after filtering, narrowing, or otherwise fine-tuning the data subject assessment results to identify such a subset of documents, a report on the data subject assessment results can be generated (1713). In one embodiment, the report can be exported as a file in a format that is suitable for distribution over a network (e.g., by email). At this point, an administrator can take further action to dispose or move the subset of documents to a secure location, for instance, in order to meet a compliance or security requirement.

Accordingly, the data subject assessment feature disclosed herein can provide improved accuracy of identifying various types of risks, including relationships, for a particular data subject. Further, user-configured “risk” level for individual risks adds flexibility in data subject assessment. The ability to search data subject files and combine the data subject with various types of metadata can further enhance the accuracy and provide more precise results.

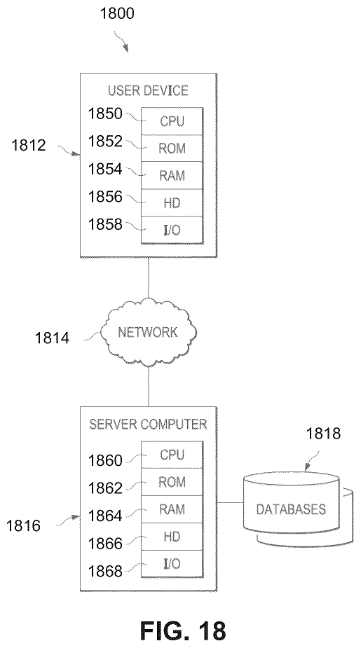

FIG. 18 depicts a diagrammatic representation of an example of a distributed network computing environment for implementing embodiments disclosed herein. In the example illustrated, network computing environment 1800 includes network 1814 that can be bi-directionally coupled to a user device 1812 and a server computer 1816 (e.g., one that operates on the premises of an enterprise or one that is hosted in a cloud computing environment). Computer 1816 can be bi-directionally coupled to databases 1818, for instance, one storing documents for data subject assessment and one storing rules. Network 1814 may represent a combination of wired and wireless networks that network computing environment 1800 may utilize for various types of network communications known to those skilled in the art.

For the purpose of illustration, a single system is shown for each of computer 1812 and computer 1816. However, with each of each of computer 1812 and computer 1816, a plurality of computers (not shown) may be interconnected to each other over network 1814. For example, a plurality of computers 1812 and a plurality of computers 1816 may be coupled to network 1814. Computers 1812 may include data processing systems for communicating with computer 1816. Computers 1812 may include data processing systems for users whose jobs may require them to create and run data subject assessment projects, build PII risk rules, generate data subject assessment reports, etc.

Computer 1812 can include central processing unit (“CPU”) 1850, read-only memory (“ROM”) 1852, random access memory (“RAM”) 1854, hard drive (“HD”) or storage memory 1856, and input/output device(s) (“I/O”) 1858. I/O 1858 can include a keyboard, monitor, printer, electronic pointing device (e.g., mouse, trackball, stylus, etc.), or the like. Computer 1812 can include a desktop computer, a laptop computer, a personal digital assistant, a cellular phone, or nearly any device capable of communicating over a network.

Likewise, computer 1816 may include CPU 1860, ROM 1862, RAM 1864, HD 1866, and I/O 1868. Computer 1816 may support an AI platform and provide AI services such as data subject assessment, language detection, image analysis, named entity extractor, semantic metadata extraction, summarization, speech-to-text, etc. to computer 1812 over network 1814. In some embodiments, database 1818 may be configured for storing data subject assessment results and/or rules.

Each of the computers in FIG. 18 may have more than one CPU, ROM, RAM, HD, I/O, or other hardware components. For the sake of brevity, each computer is illustrated as having one of each of the hardware components, even if more than one is used. Each of computers 1812 and 1816 is an example of a data processing system. ROM 1852 and 1862; RAM 1854 and 1864; HD 1856 and 1866; and databases 1818 can include media that can be read by CPU 1850 or 1860. Therefore, these types of memories include non-transitory computer-readable storage media. These memories may be internal or external to computers 1812 or 1816.

Portions of the methods described herein may be implemented in suitable software code that may reside within ROM 1852 or 1862; RAM 1854 or 1864; or HD 1856 or 1866. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer-readable medium (e.g., ROM, RAM, and/or HD), hardware circuitry or the like, or any combination thereof. Within this disclosure, the term “computer-readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer-readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

While in embodiments disclosed herein, Python is the main language for building rule scripts, other suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems. Communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer-readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the disclosure should be determined by the following claims and their legal equivalents.

What is claimed is:

1. A data subject assessment method, comprising:
defining a data subject, the defining performed by a data subject assessment service responsive to an instruction from a user, the instruction received through a user interface of the data subject assessment service, the data subject assessment service hosted on an artificial intelligence (AI) platform, the AI platform operating in a cloud computing environment;
creating a data subject project, wherein the creating the data subject project comprises associating the data subject project with a plurality of AI models, each of the plurality of AI models modeling a risk;
configuring the data subject project, the configuring the data subject project comprising setting the risk at a risk level responsive to a setting received through the user interface of the data subject assessment service;
adding the data subject to the data subject project;
running the data subject project on a collection of documents to assess the data subject, wherein the running the data subject project produces data subject assessment results;
searching for data subject relationships in the data subject assessment results, wherein the searching produces a subset of the data subject assessment results; and
generating a report on the subset of the data subject assessment results.

2. The data subject assessment method according to claim 1, further comprising:
importing a file containing data subject information.

3. The data subject assessment method according to claim 1, wherein the configuring the data subject project comprises selecting an instance of an analytic engine operating on the AI platform.

4. The data subject assessment method according to claim 1, wherein the running the data subject project comprises:
accessing a data source;
retrieving a document from the collection; and
performing data subject assessment operations on the document.

5. The data subject assessment method according to claim 4, wherein the data subject assessment operations comprise text mining operations and application of rules, wherein the text mining operations produce metadata about the document, and wherein the application of rules leverages the metadata and applies an action to the document when a condition is met.

6. The data subject assessment method according to claim 1, wherein the configuring the data subject project comprises selecting a processing language.

7. The data subject assessment method according to claim 1, further comprising:
customizing the data subject project, wherein the customizing the data subject project comprises adding another data subject to the data subject project.

8. A data subject assessment system, comprising:
a processor;
a non-transitory computer-readable medium; and
instructions stored on the non-transitory computer-readable medium and translatable by the processor for:
defining a data subject responsive to an instruction from a user, the instruction received through a user interface of a data subject assessment service, the data subject assessment service hosted on an artificial intelligence (AI) platform, the AI platform operating in a cloud computing environment;
creating a data subject project, wherein the creating the data subject project comprises associating the data subject project with a plurality of AI models, each of the plurality of AI models modeling a risk;
configuring the data subject project, the configuring the data subject project comprising setting the risk at a risk level responsive to a setting received through the user interface of the data subject assessment service;
adding the data subject to the data subject project;
running the data subject project on a collection of documents to assess the data subject, wherein the running the data subject project produces data subject assessment results;
searching for data subject relationships in the data subject assessment results, wherein the searching produces a subset of the data subject assessment results; and
generating a report on the subset of the data subject assessment results.

9. The data subject assessment system of claim 8, wherein the instructions are further translatable by the processor for:
importing a file containing data subject information.

10. The data subject assessment system of claim 8, wherein the configuring the data subject project comprises selecting an instance of an analytic engine operating on the AI platform.

11. The data subject assessment system of claim 8, wherein the running the data subject project comprises:
accessing a data source;
retrieving a document from the collection; and
performing data subject assessment operations on the document.

12. The data subject assessment system of claim 11, wherein the data subject assessment operations comprise text mining operations and application of rules, wherein the text mining operations produce metadata about the document, and wherein the application of rules leverages the metadata and applies an action to the document when a condition is met.

13. The data subject assessment system of claim 8, wherein the configuring the data subject project comprises selecting a processing language.

14. The data subject assessment system of claim 8, wherein the instructions are further translatable by the processor for:
customizing the data subject project, wherein the customizing the data subject project comprises adding another data subject to the data subject project.

15. A computer program product for data subject assessment, the compute program product comprising a non-transitory computer-readable medium storing instructions translatable by a processor for:
defining a data subject responsive to an instruction from a user, the instruction received through a user interface of a data subject assessment service, the data subject assessment service hosted on an artificial intelligence (AI) platform, the AI platform operating in a cloud computing environment;
creating a data subject project, wherein the creating the data subject project comprises associating the data subject project with a plurality of AI models, each of the plurality of AI models modeling a risk;
configuring the data subject project, the configuring the data subject project comprising setting the risk at a risk level responsive to a setting received through the user interface of the data subject assessment service;
adding the data subject to the data subject project;
running the data subject project on a collection of documents to assess the data subject, wherein the running the data subject project produces data subject assessment results;
searching for data subject relationships in the data subject assessment results, wherein the searching produces a subset of the data subject assessment results; and
generating a report on the subset of the data subject assessment results.

16. The computer program product of claim 15, wherein the instructions are further translatable by the processor for:
importing a file containing data subject information.

17. The computer program product of claim 15, wherein the running the data subject project comprises:
accessing a data source;
retrieving a document from the collection; and
performing data subject assessment operations on the document.

18. The computer program product of claim 17, wherein the data subject assessment operations comprise text mining operations and application of rules, wherein the text mining operations produce metadata about the document, and wherein the application of rules leverages the metadata and applies an action to the document when a condition is met.

19. The computer program product of claim 15, wherein the configuring the data subject project comprises selecting a processing language.

20. The computer program product of claim 15, wherein the instructions are further translatable by the processor for:
customizing the data subject project, wherein the customizing the data subject project comprises adding another data subject to the data subject project.
